(19) United States
(12) Patent Application Publication
(10) Pub. No.: US 2013/0029169 A1
(43) Pub. Date: Jan. 31, 2013

(54) METHOD FOR PRODUCING MULTICOLOURED COATINGS

(71) Applicants: Robert Hammond-Smith, Salisbury (GB); Philip Edward May, Sidcup (GB)

(72) Inventors: Robert Hammond-Smith, Salisbury (GB); Philip Edward May, Sidcup (GB)

(73) Assignee: MERCK PATENT GESELLSCHAFT MIT BESCHRANKTER HAFTUNG, Darmstadt (DE)

(21) Appl. No.: 13/638,131

(22) PCT Filed: Mar. 3, 2011
(86) PCT No.: PCT/EP2011/001055

§ 371 Date: Sep. 28, 2012

(30) Foreign Application Priority Data
Mar. 30, 2010 (EP) 10003447.9

(51) Int. Cl. B05D 5/06; B32B 29/00; B32B 33/00

(52) U.S. Cl. 428/537.5; 427/162; 428/411.1

(57) ABSTRACT

The present invention relates to a method for producing multicoloured coatings on substrates, whereby a first and a second coating composition are subsequently coated onto a substrate by partially overlapping each other in a wet-on-wet state, the first and the second coating containing a polymerisable nematic liquid crystal material, followed by polymerisation of the resulting coating, to a multicoloured coating produced by said method as well as to products comprising said multicoloured coating.

The invention relates to a method for producing multicoloured coatings on substrates, whereby a first and a second coating composition are subsequently coated onto a substrate by partially overlapping each other in a wet-on-wet state, the first and the second coating composition each containing a polymerisable nematic liquid crystal material, followed by polymerisation of the resulting coating, to a multicoloured coating produced by said method as well as to products, in particular decorative and security products, comprising said multicoloured coating.

Usually, if multicoloured coatings are to be produced on substrates such as paper, board or polymer films, several techniques are known in the art. Although it would in principle be possible to coat each of the different areas of, for example, a multicoloured image in exactly the colour it should exhibit in the end, such a procedure would not be of commercial interest due to the either limited numbers of colours which would be achievable or due to the huge number of colour compositions and coating steps which had to be used when multicoloured coatings had to be produced. Therefore, in particular in industrial printing of multicoloured images, the application of the so called CMYK colour concept is state of the art, using the three basic colours Cyan, Magenta and Yellow, combined with Black, which are printed one on top of the other to give multicoloured images exhibiting a huge variety of colour hues which might be produced by varying the ratio of cyan, magenta, yellow and black at each single point or area of the multicoloured image. This colour concept applies to absorption colours undergoing a subtractive colour mixing, where a black colour is achieved when all colours are applied one on top of each other in an equal amount.

In contrast thereto, coloured light is additively mixed, leading to a white hue when all of the basic RGB colours (Red, Green, Blue) are applied one on top of the other in an equal amount. This concept is used in colour TV or on computer screens, where the coloured pictures are built by a huge amount of pixels being composed of red, blue or green light points.

Unlike ordinary printing inks, which contain absorption pigments, printing inks or coating compositions containing pearlescent or interference effect pigments undergo additive colour mixing, when several interference pigments exhibiting different interference colours are printed one on top of the other. This is due to the fact that the colour exhibited by those pigments is merely the result of the interference of light not including any absorption colour.

Similar effects of additive colour mixing may be observed when cholesteric liquid crystal compositions are applied one on top of the other, since the observable colour of cholesteric liquid crystal compositions, if any, is the result of mere light interaction of a, per se, colourless substance. The additive colour mixing may be observed when two layers containing different kinds of cholesteric LC pigments are applied one on top of the other or when a cholesteric polymer LC film is applied on top of a further cholesteric polymer LC film containing a LC composition which reflects a different colour hue than the overlying LC layer does.

The additive colour mixing effects mentioned above may be used inter alia in coating compositions for, especially, printing applications, leading to outstanding colour effects such as optically variable colours (where one colour is observed when viewed under a perpendicular viewing angle and at least one second colour is observed when viewed under an acute viewing angle) and/or to optical effects which might not be achieved by usual printing methods using the subtractive colour mixing concept, e.g. an observable colour by using a transparent coating without any absorption colorants. These applications are in particular interesting for several decorative and security products.

In WO 2005/105474 a security element and a method for producing the same are disclosed, wherein the security element comprises two optically active layers consisting of a cholesteric liquid crystal composition each which are superimposed in an overlapping zone. Since the optically active cholesteric LC film layers are laminated or otherwise applied one on top of the other, additive colour mixing takes place in the overlapping zones, leading to an observable third colour at the overlapping zones which is different from the two colours which may be observed at the non-overlapping zones.

EP 1 894 736 A2 discloses a security element comprising an optically variable motif layer and a method for its production, comprising the application of a first non-chiral LC layer onto a substrate, partially cross-linking said LC layer, applying a second layer comprising a chiral LC material exhibiting an optically variable behaviour onto the first layer and then partially or totally cross-linking said second LC layer. The LC material of the underlying layer and the LC material of the overlying layer interact with each other, leading to an observable second colour which is different from the first colour being observable in the non-overlapping zones of the security element which is due to the optical light interaction of the second LC layer comprising a chiral LC material.

It is the object of the present invention to provide a method for producing multicoloured coatings on substrates using liquid crystalline coating compositions, whereby highly versatile multicoloured coatings may be produced by using only so few as two different liquid crystalline materials, whereby the coatings exhibit at least three and at best a greater variety of different colours which are visible either with polarisers or under illumination outside the visible light spectrum, or, alternatively or in addition, under usual light conditions with the naked eye, optionally also exhibiting an optically variable behaviour.

Furthermore, it is the object of the present invention to provide a multi-coloured coating on a substrate exhibiting the optical characteristics mentioned above.

A further object of the present invention is to provide a product containing said multicoloured coating, advantageously using the optical characteristics mentioned above.

The object of the present invention is achieved by a method for producing multicoloured coatings on a substrate by coating a first coating composition containing a first polymerisable nematic liquid crystal material onto a substrate and subsequently coating a second coating composition containing a second polymerisable nematic liquid crystal material onto the substrate while the first coating composition is still in an unpolymerised state, wherein the first and the second coating composition overlap in least one defined area, followed by polymerisation of the resulting coating.

Furthermore, the object of the invention is achieved by a multicoloured coating on a substrate, being produced by the aforementioned method.

In addition, the object of the present invention is achieved by a product, containing said multicoloured coating.

In the following, the technical terms used in the present invention shall be defined:

The term ‘substrate’ as used in this application refers to any underlying layer or substrate.

The term ‘film’ as used in this application includes self-supporting, i.e. free-standing, films that show more or less pronounced mechanical stability and flexibility, as well as coatings or layers on a supporting substrate or between two substrates.

The term ‘liquid crystal or mesogenic material’ or ‘liquid crystal or mesogenic compound’ should denote materials or compounds comprising one or more rod-shaped, board-shaped or disk-shaped mesogenic groups, i.e. groups with the ability to induce liquid crystal phase behaviour. The compounds or materials comprising mesogenic groups do not necessarily have to exhibit a liquid crystal phase themselves. It is also possible that they show liquid crystal phase behaviour only in mixtures with other compounds, or when the mesogenic compounds or materials, or the mixtures thereof, are polymerized.

For the sake of simplicity, the term ‘liquid crystal material’ is used herein-after for both liquid crystal materials and mesogenic materials, and the term ‘mesogen’ is used for the mesogenic groups of the material.

The term ‘planar structure’ or ‘planar orientation’ means that the liquid crystal director, i.e. the preferred orientation direction of the main molecular axes of the mesogens in the liquid crystal material, is substantially parallel to the plane of the film or layer. This definition also includes films wherein the director is slightly tilted relative to the film plane, with an average tilt angle throughout the film of up to 1°, and which exhibit the same optical properties as a film wherein the director is exactly parallel, i.e. with zero tilt, to the film plane.

The term ‘helically twisted structure’ relates to a film comprising one or more layers of liquid crystal material wherein the mesogens are oriented with their main molecular axis in a preferred direction within molecular sublayers, with this preferred orientation direction in different sublayers being twisted around a helix axis that is substantially perpendicular to the film plane, i.e. substantially parallel to the film normal. This definition includes orientations of the helix axis from 75 to 90°, preferably 80 to 90°, very preferably 85 to 90° and most preferably 88 to 90° relative to the film plane.

Materials which are useful for the preparation of such helically twisted structures are in particular liquid crystal materials that exhibit a chiral mesophase, wherein the mesogens are oriented with their main molecular axis twisted around a helix axis, like e.g. a chiral nematic (cholesteric) or a chiral smectic phase. Materials exhibiting a cholesteric phase are preferred.

The term ‘nematic liquid crystal’ relates to rod-shaped liquid crystal materials or mesogens which are oriented planar to the plane of the film or layer.

The term ‘chiral dopant’ relates to a chiral compound which can also be mesogenic and which is capable to induce the helically twisted cholesteric phase structure in a nematic host material. The ability of a chiral compound to induce a cholesteric structure with a helical pitch in a nematic host material is called its helical twisted power (HTP). If a compound with a high HTP is used, only a small amount is sufficient to achieve a cholesteric structure with reflection of visible light. As the pitch of the cholesteric helix is dependent on the chemical constitution and the concentration of the chiral compound, and as the pitch is directly related to the wavelength of the reflection maximum, the colour properties of a cholesteric liquid crystalline composition can be directly controlled by varying the type and the ratio of the chiral mesogenic compound, i.e. the ‘chiral dopant’.

In the method of the present invention, a first coating composition containing a first polymerisable nematic liquid crystal material is coated onto a substrate, followed by coating a second coating composition containing a second polymerisable nematic liquid crystal material, wherein the first and the second coating compositions overlap in at least one defined area and wherein the first coating composition is still in a wet, unpolymerised state, subsequently followed by polymerisation and thereby cross-linking of the resulting coating.

As substrate in principle any substrate which may be coated by common coating techniques, in particular in the manufacturing of decorative and security products, may be used. Accordingly, useful substrates which may be used for the production of the present multicoloured coatings are for example polymer films such as pre-coated PET, pigmented or dyed PET films, polyethylene films, polypropylene films, polyethylene terephthalate films, cellulosic films, triacetyl cellulose films, or films made of co-polymers thereof, all of them optionally in addition containing a release coating, but also metallisied substrates, metal foils such as aluminium foil, paper, card board, wall paper, bank note paper etc., which may optionally be pre-coated or pre-printed. The substrates may also be composed of layered films which may contain different polymers in each layer, e.g. hot stamping foils, of combinations of polymers with paper or card board, etc.

Preferred substrates are polymeric substrates which are reflective, i.e. coated with a reflective layer, in the case that solely nematic liquid crystal materials are used and dark, preferably black, in the case that cholesteric liquid crystal materials (nematic host material in combination with chiral dopant) are used.

Coating may be performed by usual coating techniques by means of which the coated amount of each coating composition onto a defined area of the substrate may be controlled precisely. Although common coating techniques such as bar coating, gravure coating and reverse coating are in general useful for executing the method of the present invention, printing techniques are preferred, since by means of printing techniques in general it is much easier to control the amount of a coating composition (i.e. of the printing ink) which is applied onto a discrete area of the substrate.

Regarding useful printing techniques, preference is given to printing techniques where the size of the coated areas (the printing dots) may be varied and controlled to a large extend. In particular, gravure printing techniques, flexographic printing techniques and ink jet printing is preferred.

By defined area, a small area on the surface of the substrate is meant, being for example in the shape of a motif, an alphanumeric character, a line, a microtext, a picture, a barcode, a logo, a trade mark, a computer generated picture or object or parts thereof. In the simplest way, the defined area is simply the area which is covered by one single drop of the coating composition. Since the kind of the defined area is as variable as mentioned before, the size thereof may vary, from some square-micrometers to some square-millimeters or even square-centimeters. The smaller the size of the defined area, the better the amount of the corresponding coating composition applied thereon may be controlled, e.g. by the precision of the coating machines which are used.

In a first embodiment of the present invention, the first and the second coating compositions both contain, preferably as the sole liquid crystal material, a polymerisable nematic liquid crystal material each exhibiting a nematic liquid crystal behaviour, i.e. a planar alignment onto the substrate surface when polymerised.

In the simplest form, the first and second coating composition is the very same composition. When this coating composition is applied in two coating steps subsequently onto the substrate, the coated parts which do not overlap exhibit a wet thickness of the coating which depends on the coating apparatus and/or the coating technique used. Therefore, even by applying the same coating composition onto a substrate in different coating steps, the thickness of the resulting coating of each step may be varied. In addition, exhibiting the method of the present invention, the coating composition overlaps in at least one defined area of the coated substrate. On this area, the amount of the coating composition, comprising the coating composition amount of the first coating step and the coating composition amount of the second coating step add to the resulting coating amount onto that area, leading to a larger wet thickness of the coating and, depending thereon, also to a larger dry thickness of the resulting coating on that area. It goes without saying that the surface tension of the coating composition has to be selected in such a way that the added amounts of the first and second coating compositions on the defined area do lead to a higher thickness of the coating on that area rather than to a bigger area coated. Besides the kind of the chemical components of the coating composition, the thickness of the coating determines the optical characteristics of the resulting (polymerised) coating. Thus, by applying one single coating composition containing a polymerisable nematic liquid crystal material exhibiting a nematic liquid crystal behaviour in two different wet-on-wet coating steps, whereby the coated areas partly overlap, may lead, depending on the number of different coating techniques or coating apparatuses used, to a coated area containing part areas exhibiting at least two, but conveniently also three or even more different thicknesses. When viewed under a linear polariser at the correct orientation, being parallel or perpendicular to the director, these areas exhibit a different reflection colour each, leading to a multicoloured coated area which is visible when viewed under linear polarized light, but is colourless when viewed under ambient light conditions. By application of suitable overlayers it is possible to make the printed area invisible when viewed under normal conditions.

The number of possible colours visible under the above mentioned circumstances may be extended by using two different coating compositions containing a polymerisable nematic liquid crystal material exhibiting a nematic liquid crystal behaviour, preferably as the sole liquid crystal material, each, whereby the first and the second polymerisable nematic liquid crystal materials differ in their birefringence. In this case, a three coloured coating is conveniently available by coating the first coating composition in a first coating step, followed by coating the second coating composition in a second coating step, whereby the coating technique and apparatus for each coating step may be the same, so that the coating thickness achieved in the first coating step and the coating thickness achieved in the second coating step is the same in the non-overlapping areas. On the overlapping area, the coating thickness is the sum of the coating thickness of the first coating step and the coating thickness of the second coating step. Whereas the colour, which may be seen when the coated substrate is viewed under ambient light by means of a linear polariser, of the first and second coating on the non-overlapping areas differ due to the different birefringence of the first and second coating composition, the birefringence on the overlapping area is different from each of the birefringences of the single coatings. The colour of the overlapping area is, therefore, determined by the birefringence of the resulting mixture of the first and second coating composition on that area as well as on the thickness of the resulting (dry) coating on that area. In the case that the thickness of the non-overlapping parts on the surface coated with the corresponding first and second coating compositions is varied, which may easily be accomplished by e.g. using engraved printing forms having printing cells with different depth thereon, a multicoloured coating exhibiting more than three different colours may be achieved, by using merely two different coating compositions.

In a second embodiment of the present invention, at least one of the first or second coating compositions contains a chiral dopant in addition to the polymerisable nematic liquid crystal material. As described earlier, a chiral dopant is a chiral compound which is capable to induce the helically twisted cholesteric phase structure in a nematic host material. The length of the pitch which can be defined as the vertical distance between two molecules which are in the same orientation is determined by the HTP of the chiral dopant. The pitch determines the reflection wavelength of the liquid crystal composition containing the chiral dopant within the light spectrum. The main reflection wavelength may vary from shorter wavelengths in the UV region via the visible wavelength region to the longwave IR region, which is invisible to the naked eye like the UV region. In the multicoloured coating according to the present invention there may be reflection maxima of one particular cholesteric liquid crystal material located in either of the visible or invisible regions described before. Since a chiral dopant with a large HTP shifts the main reflection wavelength of the resulting cholesteric liquid crystal material to shorter wavelengths, a small amount thereof is sufficient to end up with at least one reflection wavelength in the visible region of the spectrum.

Using the identical nematic liquid crystal host material, the pitch thereof, and therewith, the main reflection wavelength, may be determined by the kind and amount of the chiral dopant used. In case that also the same chiral dopant should be used, alteration of the mere amount thereof will lead to a different optical behaviour of each of the resulting cholesteric liquid crystal materials, depending on the amount of the chiral dopant which is added. Therefore, executing the method of the present invention, by applying a first coating composition onto the substrate and subsequently a second coating composition in a second coating step, wherein at least one of the first or second coating compositions contains a chiral dopant, the colour of the resulting coating on the overlapping area will be determined by the kind and amount of the chiral dopant.

Although the colour of the coating on the overlapping area may lay still in the invisible, i.e. infrared (IR) region of the spectrum, it lays in most cases in the visible region of the spectrum and may vary within the whole range of colours in the visible spectrum, ranging from the long wave red to the short wave violet. Usually, this reflection colour is the colour which is visible under ambient illumination at a perpendicular viewing angle. In most cases, each of the reflection colours is accompanied by a second reflection colour which may be viewed under the same light conditions, but at an acute viewing angle. This behaviour of the cholesteric liquid crystal materials is called optically variable, i.e. the same material exhibits different reflection colours under different viewing or illumination angles. Sometimes, the second reflection colour is already in the invisible region of the spectrum and may be observed by means of the corresponding illumination source and detection equipment only.

Thus, by varying the mixing ratio of the first and second coating composition on the overlapping area, different reflection colours of the resulting coating may be observed, which may also be optically variable. The colour of the coating in the non-overlapping areas of the coated substrate depends on the kind of the liquid crystal material used as well as on the thickness of the coating. As already described above, a variation of the thickness of the coating within the area coated with only one of the first or second coating composition is also easily available by variation of the coating procedure, apparatuses or simply the depth of the engraved cells of the printing form. Therefore, when a first nematic liquid crystal material is used for the first coating composition and a second nematic liquid crystal material containing a chiral dopant is used for the second coating composition of the present invention, multicoloured coatings are easily available, leading to a great variety of colours in the overlapping areas as well as to a combination of colours which might be visible when viewed by means of a linear polariser only as well as colours which are due to the second coating composition only, the latter also being capable to be varied in its thickness. In addition, all of the colours visible in the visible wavelength region of the spectrum at a perpendicular viewing angle may also be accompanied by a second reflection colour which is visible under an acute viewing angle only. Such a multicoloured coating may be achieved in case that only two different coating compositions according to the present invention are used, at least one of them containing a chiral dopant.

In a third embodiment of the present invention, the first as well as the second coating composition contain a chiral dopant. It goes without saying that either the chemistry, the handedness, or the amount, or any combination of these, of the chiral dopant may be varied between the first and second coating composition. Similar to the second embodiment, the colour of the coating on the overlapping area will be determined by a mixture of a particular amount of the first coating composition with a particular amount of the second coating composition, resulting in a particular mixing weight ratio of said coating compositions on said overlapping area. Since both coating compositions contain a chiral dopant, the resulting mixed compound will exhibit a chiral nematic (cholesteric) optical behaviour too. Unlike a mixture of a nematic with a cholesteric coating composition according to embodiment two, in case the reflection maxima of the mixed coating compositions in embodiment three are localised in the visible spectrum of the light, the reflection maximum and, due to it, the colour of the corresponding mixed coating on the overlapping area will lay merely within the range in between the reflection maximum of the first coating composition and the reflection maximum of the second coating composition. Therefore, a coated overlapping area according to the present invention comprising parts of a green reflecting cholesteric LC material and parts of a red reflecting cholesteric LC material will lead to an orange, yellow or yellowish green reflection colour of the resulting coating, dependent on the mixing ratio of the first and second coating composition on the overlapping area. These colours belong to the reflection perceived under a perpendicular viewing angle. Under an acute viewing angle, the corresponding reflection colours would vary from yellowish green via green to bluish green. On the other side, a blue reflecting first coating composition and a red reflecting second coating composition may lead to bluish green, green, yellowish green, yellow, orange and red reflection colours in the overlapping area, viewed under a perpendicular viewing angle, and to violet, blue, bluish green, green and yellowish green reflection colours when viewed under an acute viewing angle. The sequence of coating the corresponding coating compositions is not of big importance here, that means that, if a blue reflecting coating composition and a red reflecting coating composition are used, either of them may serve as the first and second coating composition, leading to multicoloured coatings exhibiting equivalent multicoloured effects in the end.

In addition, either one or both of the reflection maxima of the first and second cholesteric coating composition may lay in the infrared or ultraviolet portion of the spectrum. In that case, the reflection maximum of the mixed coating on the overlapping area will also lay between the two single reflection maxima, and may therefore lay either within the UV, IR or visible wavelength range.

According to the present invention, there may exist two or more defined areas on the coated substrate where the first and second coating composition overlap, and in at least one defined area the first and second coating composition overlap at a first mixing weight ratio, while in a second defined area, they overlap at a second mixing weight ratio, the first and second mixing weight ratio being different from each other. The number of different defined areas comprising a different mixing ratio of the first and second coating composition on each area may be chosen by will and is merely limited by the coating techniques, apparatuses or printing forms which are used for the first and second coating step according to the coating method of the present invention.

In addition, also the thickness of the coating on the areas coated with either the first or the second coating composition may be varied from place to place, leading to colour variations within these regions of the coated substrate. Furthermore, the optically variable behaviour of the corresponding coatings as described for embodiment two does also apply to the coatings corresponding to embodiment three.

In case the coatings which may be achieved by the third embodiment of the present invention have reflection maxima in the visible portion of the spectrum, the resulting colours of the coatings are visible under at least one viewing angle and at best under at least two different viewing angles (optically variable) and the coatings will be multicoloured in the visible spectrum, whereby at least the colours visible in the defined overlapping areas may be chosen by determining the mixing ratio of the first and second coating composition on that defined area. As already described, this may e.g. be accomplished by determining the applied amount of each coating composition via the size and depth of the printing cells which transport the corresponding coating composition to the substrate.

In case the reflection maxima of either the first and second coating compositions, or both, lay outside the visible portion of the spectrum, the colours of the coatings in the overlapping areas may be visible in the IR, the UV or the visible portion of the spectrum, depending on the circumstances.

Preferred materials for the first and second coating compositions and their circumstances of visibility are mentioned in the following:

| 1^{st} Coating | 2^{nd} Coating | Effect and Viewing |
|---|---|---|
| Composition | Composition | conditions for mixed area |
| Nematic LC | Nematic LC same | Colour visible through |
| | birefringence as 1^{st} | linear polariser |
| Nematic LC | Nematic LC different | Colour visible through |
| | birefringence from 1^{st} | linear polariser |
| Nematic LC | Cholesteric LC | Colour with longer wave- |
| | | length than cholesteric LC |
| Cholesteric | Cholesteric with same | Reflection with wavelength |
| | handedness and Reflection | between 1^{st} and 2^{nd} |
| | Wavelength different from | |
| | 1^{st} | |
| Cholesteric | Cholesteric with opposite | Reflection with longer |
| | handedness and Reflection | wavelength than either 1^{st} or |
| | Wavelength same as 1^{st} | second. Handedness depends |
| | | upon ratio of mixing |
| Cholesteric | Cholesteric with opposite | Reflection with longer |
| | handedness and Reflection | wavelength than either 1^{st} or |
| | Wavelength different from | second. Handedness depends |
| | 1^{st} | upon ratio of mixing |
| Cholesteric | Cholesteric with opposite | UV, Visible or IR Reflection |
| with UV | handedness and UV | with handedness depending |
| Reflection | Reflection different from | upon ratio of mixing |
| | 1st | |

The polymerisable liquid crystal material which is contained in the first and second coating composition according to the present invention is preferably a nematic, chiral nematic (cholesteric) or chiral smectic material. Nematic materials and cholesteric materials are especially preferred. In case of a cholesteric material, preferably the substrate onto which the coating composition is coated is a substrate comprising a light absorbing material, like a dark or black substrate, or a comparable layer is applied to the substrate prior to coating the first and second coating composition. For nematic materials, the use of a reflecting substrate or of a reflecting layer as a substrate or on top of a substrate prior to coating the first and second coating composition according to the present invention is advantageous.

For devices combining both nematic and cholesteric effects the substrate could be selectively coated with a dark layer to maximise the visual effect of the cholesteric.

The liquid crystal material used in the method of the present invention is preferably a polymerisable or crosslinkable material, which may or may not be dissolved in an organic solvent, that is polymerised or crosslinked during or after evaporation of the solvent. It preferably comprises at least one polymerisable mesogenic compound having one polymerisable functional group and at least one polymerisable mesogenic compound having one or more polymerisable functional groups.

If the polymerisable LC material comprises polymerisable mesogenic compounds having one or more polymerisable functional groups (mono- or multireactive or mono-or multifunctional compounds), upon polymerisation a three-dimensional polymer network is formed, which may even be self-supporting and shows a high mechanical and thermal stability and a low temperature dependence of its physical and optical properties. By varying the concentration of the multifunctional mesogenic or non mesogenic compounds the crosslink density of the resulting polymer coating and thereby its physical and chemical properties such as the glass transition temperature, which is also important for the temperature dependence of the optical properties of the polymerised coating, the thermal and mechanical stability or the solvent resistance can be tuned easily.

The polymerisable mesogenic mono-, di- or multireactive compounds can be prepared by methods which are known per se and which are described, for example, in standard works of organic chemistry such as, for example, Houben-Weyl, Methoden der organischen Chemie, Thieme-Verlag, Stuttgart. Typical examples are described for example in WO 93/22397; EP 0 261 712; DE 19504224; DE 4408171 and DE 4405316. The compounds disclosed in these documents, however, are to be regarded merely as examples that do not limit the scope of this invention.

Examples representing especially useful monoreactive polymerisable mesogenic compounds are shown in the following list of compounds, which should, however, be taken only as illustrative and is in no way intended to restrict, but instead to explain the present invention:

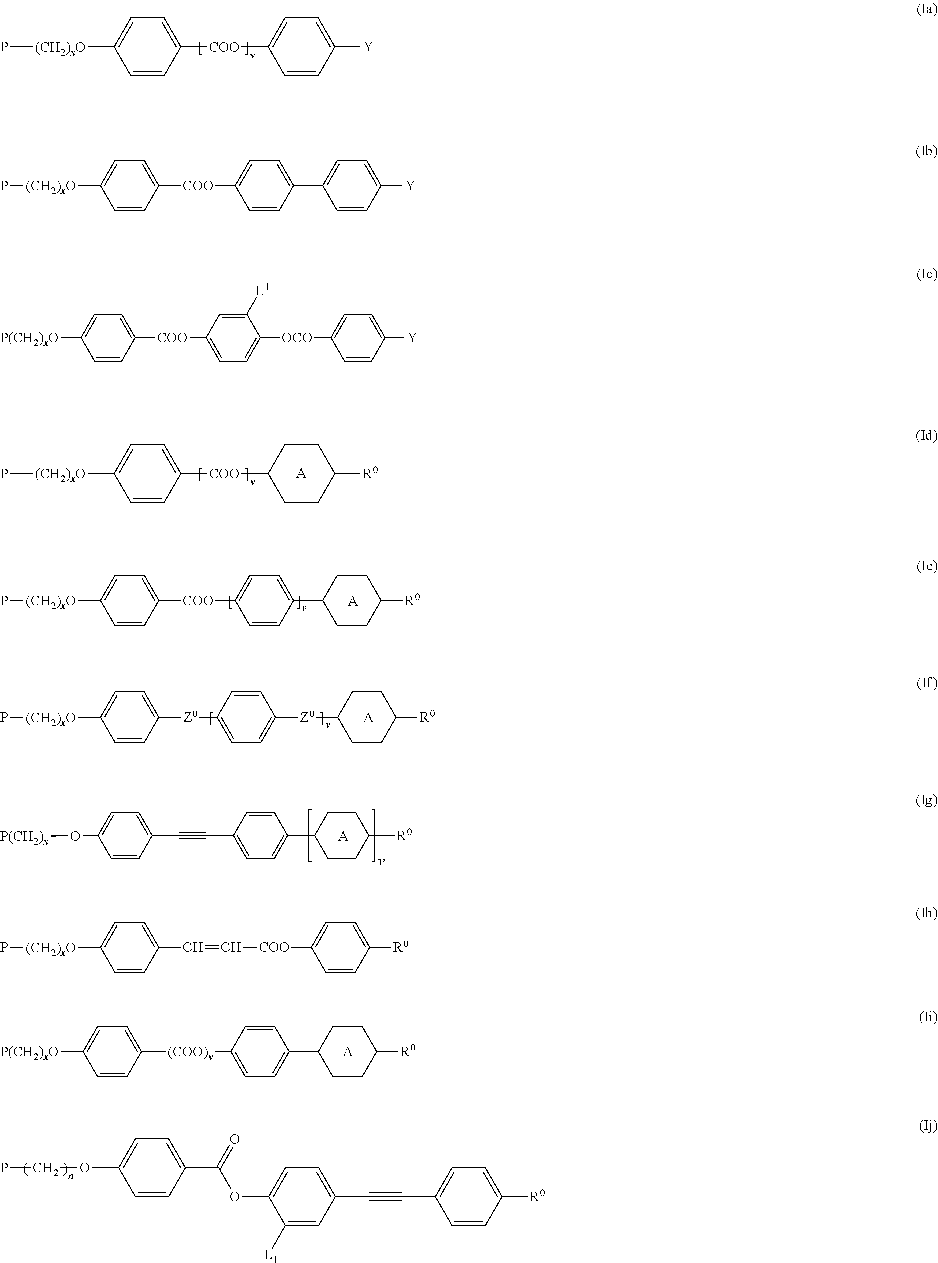

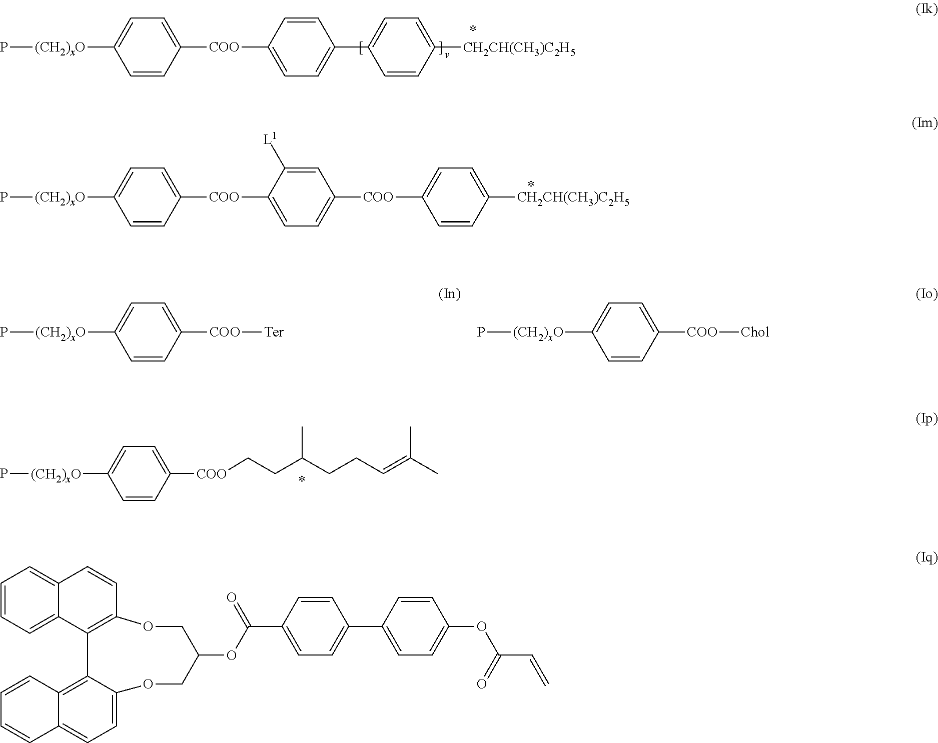

Examples of useful direactive polymerisable mesogenic compounds are shown in the following list of compounds, which should, however, be taken only as illustrative and is in no way intended to restrict, but instead to explain the present invention:

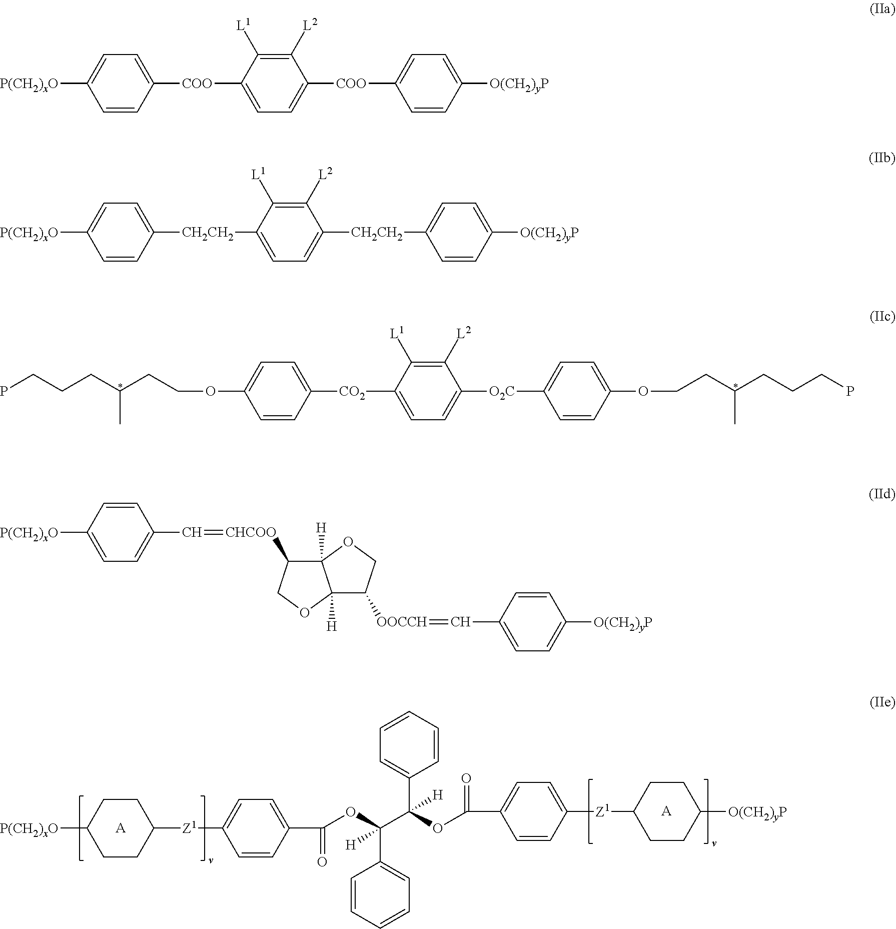

In the above formulae, P is a polymerisable group, preferably an acryl, methacryl, vinyl, vinyloxy, propenyl ether, epoxy or styryl group, x and y are each independently 1 to 12, A is 1,4-phenylene that is optionally mono- di or trisubstituted by L¹ or 1,4-cyclohexylene, v is 0 or 1, Z⁰ is —COO—, —OCO—, —CH₂CH₂— or a single bond, Y is a polar group, Ter is a terpenoid radical like e.g. menthyl, Chol is a cholesteryl group, R⁰ is an nonpolar alkyl or alkoxy group, and L¹ and L² are each independently H, F, Cl, CN or an optionally halogenated alkyl, alkoxy, alkylcarbonyl, alkoxycarbonyl or alkoxycarbonyloxy group with 1 to 7 C atoms.

The term ‘polar group’ in this connection means a group selected from F, Cl, CN, NO₂, OH, OCH₃, OCN, SCN, an optionally fluorinated carbonyl or carboxyl group with up to 4 C atoms or a mono- oligo- or polyfluorinated alkyl or alkoxy group with 1 to 4 C atoms. The term ‘nonpolar group’ means an alkyl group with 1 or more, preferably 1 to 12 C atoms or an alkoxy group with 2 or more, preferably 2 to 12 C atoms.

In case cholesteric liquid crystal (CLC) materials are used, these preferably comprise a nematic or smectic host material and one or more chiral dopants that induce a helical twist in the host material. The chiral dopants can be polymerisable or not. They can be mesogenic or liquid crystal compounds, but do not necessarily have to be liquid crystalline.

Especially preferred are chiral dopants with a high helical twisting power (HTP), in particular as disclosed in WO 98/00428. Further typically used chiral dopants are e.g. the commercially available S 1011, R 811 or CB 15 (from Merck KGaA, Darmstadt, Germany).

Very preferred are chiral dopants selected from the following formulae

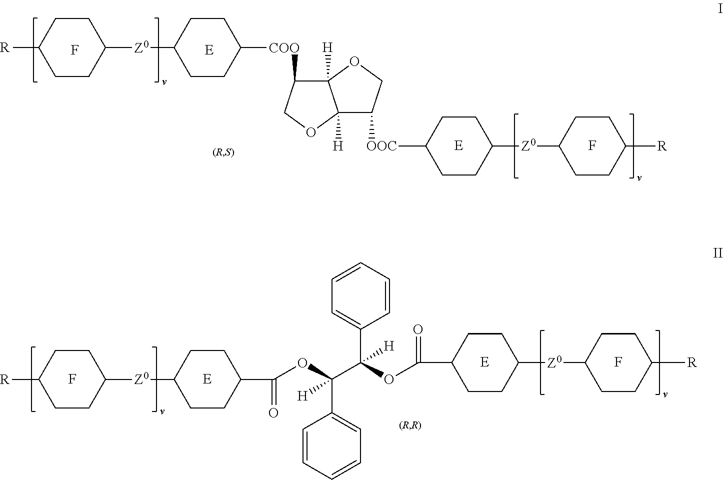

including the (R,S), (S,R), (R,R) and (S,S) enantiomers not shown, wherein E and F have each independently one of the meanings of A given above, v is 0 or 1, Z⁰ is —COO—, —OCO—, —CH₂CH₂— or a single bond, and R is alkyl, alkoxy, carbonyl or carbonyloxy with 1 to 12 C atoms.

The compounds of formula I are described in WO 98/00428, the compounds of formula II synthesis are described in GB 2,328,207, the entire disclosure of which is incorporated into this application by reference.

Polymerisable chiral compounds are preferably selected from the above formulae Ik to Iq, and IIc to IIe. It is also possible to use compounds of formula Ia to Ij wherein R⁰ or Y comprise a chiral C atom.

The amount of chiral dopants in the liquid crystal material is preferably less than 15%, in particular less than10%, very preferably less than 5% by weight of the total LC material (without the solvent).

Examples of useful chiral compounds are shown in the above list of compounds, which should, however, be taken only as illustrative and is in no way intended to restrict, but instead to explain the present invention.

Polymerisation of the polymerisable liquid crystal material takes place by exposing it to heat or actinic radiation. Actinic radiation means irradiation with light, like UV light, IR light or visible light, irradiation with X-rays or gamma rays or irradiation with high energy particles, such as ions or electrons. Preferably polymerisation is carried out by UV irradiation. As a source for actinic radiation for example a single UV lamp or a set of UV lamps can be used. When using a high lamp power the curing time can be reduced. Another possible source for actinic radiation is a laser, like e.g. a UV laser, an IR laser or a visible laser.

The polymerisation is carried out in the presence of an initiator absorbing at the wavelength of the actinic radiation. For example, when polymerising by means of UV light, a photoinitiator can be used that decomposes under UV irradiation to produce free radicals or ions that start the polymerisation reaction. When curing polymerisable mesogens with acrylate or methacrylate groups, preferably a radical photoinitiator is used, when curing polymerisable mesogens vinyl and epoxide groups, preferably a cationic photoinitiator is used. It is also possible to use a polymerisation initiator that decomposes when heated to produce free radicals or ions that start the polymerisation. As a photoinitiator for radical polymerisation for example the commercially available Irgacure 651®, Irgacure 184®, Darocur 1173® or Darocur 4205® (all from Ciba Geigy AG) can be used, whereas in case of cationic photopolymerisation the commercially available UVI 6974® (Union Carbide) can be used. The polymerisable LC material preferably comprises 0.01 to 10% by weight, very preferably 0.05 to 7%, in particular 0.1 to 5% of a polymerisation initiator. UV photoinitiators are preferred, in particular radical forming UV photoinitiators.

The curing time is dependant, inter alia, on the reactivity of the polymerisable mesogenic material, the thickness of the coated layer, the type of polymerisation initiator and the power of the UV lamp. The curing time according to the invention is preferably not longer than 1 minute, particularly preferably not longer than 30 seconds. For continuous production short curing times of 30 seconds or less, very preferably of 10 seconds or less, are preferred.

The polymerisable liquid crystal material can additionally comprise one or more other suitable components such as, for example, catalysts, sensitisers, stabilisers, inhibitors, co-reacting monomers, surface-active compounds, lubricating agents, wetting agents, dispersing agents, hydrophobing agents, adhesive agents, flow improvers, defoaming agents, deaerators, diluents, anti-oxidants, reactive diluents, auxiliaries, colourants, dyes or pigments.

Usually, the coating compositions used in the method according to the present invention contain at least one solvent as known in the art.

The surface tension of both the solution and the liquid crystal formulation is controlled by choice of surface-active compounds including wetting agents, and solvents.

In particular the addition of stabilisers is preferred in order to prevent undesired spontaneous polymerisation of the polymerisable material for example during storage. As stabilisers in principal all compounds can be used that are known to the skilled in the art for this purpose. These compounds are commercially available in a broad variety. Typical examples for stabilisers are 4-ethoxyphenol or butylated hydroxytoluene (BHT).

Other additives, like e.g. chain transfer agents, can also be added to the polymerisable material in order to modify the physical properties of the resulting polymer coating. When adding a chain transfer agent, such as monofunctional thiol compounds like e.g. dodecane thiol or multifunctional thiol compounds like e.g. trimethylolpropane tri(3-mercaptopropionate), to the polymerizable material, the length of the free polymer chains and/or the length of the polymer chains between two crosslinks in the resulting polymer film can be controlled. When the amount of the chain transfer agent is increased, the polymer chain length in the obtained polymer film is decreased.

It is also possible, in order to increase crosslinking/hardness of the polymers, to add up to 20% of a non mesogenic compound with one or more polymerisable functional groups to the polymerisable material alternatively or in addition to the mono- or multifunctional polymerisable mesogenic compounds to increase crosslinking of the polymer. To increase the hardness of the polymer mono functional cyclic acrylates such as isobornyl acrylate can be used. Typical examples for difunctional non-mesogenic monomers are alkyldiacrylates or alkyldimethacrylates with alkyl groups of 1 to 20 C atoms. Typical examples for non-mesogenic monomers with more than two polymerisable groups are trimethylolpropane trimethacrylate or pentaerythritol tetraacrylate.

In another preferred material composition the mixture of polymerisable material comprises up to 70%, preferably 3 to 50% of a non-mesogenic compound with one polymerisable functional group. Typical examples for monofunctional non-mesogenic monomers are alkylacrylates or alkylmethacrylates.

It is also possible to add, for example, a quantity of up to 20% by weight of a non-polymerisable liquid-crystalline compound to adapt the optical properties of the resulting polymer coating.

The polymerisation is preferably carried out in the liquid crystal phase of the polymerisable material. Therefore, preferably polymerisable mesogenic compounds or mixtures with low melting points and broad liquid crystal phase ranges are used. The use of such materials allows a reduction of the polymerisation temperature, which makes the polymerisation process easier and is a considerable advantage especially for continuous production. The selection of suitable polymerisation temperatures depends mainly on the clearing point of the polymerisable material and inter alia on the softening point of the substrate. Preferably the polymerisation temperature is at least 30 degrees below the clearing temperature of the polymerisable mesogenic mixture. Polymerisation temperatures below 120° C. are preferred. Especially preferred are temperatures below 90° C., in particular temperatures of 60° C. or less.

The object of the present invention is also achieved by a multicoloured coating on a substrate, which has been produced by a method according to the present invention. Details of these multicoloured coatings have been described above. Preferred multicoloured coatings are those which exhibit at least three different colours when viewed at a perpendicular viewing angle and are produced by subsequent coating of merely two different coating compositions according to the present invention. In particular preferred are those multicoloured coatings, which exhibit at least three different colours at perpendicular viewing angle and in addition, also at least three different colours at an acute viewing angle, i.e. which are optically variable. Multicoloured coatings of this type may at best be achieved by using two cholesteric LC coating compositions having their reflection maximum in the visible region of the spectrum, each. In that case, the diverse colours of the multicoloured coating are visible with the naked eye.

In case that nematic LC coating compositions without chiral dopants are used, the colours of the multicoloured coatings may be viewed with a single linear polariser or, alternatively, through two crossed linear polarisers, whereby the polarisers have to be at the correct orientation.

As described earlier, the colours of the multicoloured coatings of the present invention may also be visible when viewed under IR or UV illumination, either alone, or in combination with ambient illumination when reflection maxima in the IR or UV region as well as in the visible region of the spectrum are present.

The object of the present invention is also achieved by a product, containing the multicoloured coating of the present invention. Products according to the present invention comprise at least one surface being coated with a multicoloured coating which has been produced according to the method of the present invention.

As products all objects are useful being capable to be coated or printed by usual coating and printing techniques, preferably by printing techniques, wherein liquid crystal materials may be used in the coating compositions. Products may be, in particular, coated flat substrates such as papers, boards, wall papers, decorative products and, in particular, security products, preferably for product or identification labels or security markings on documents of value like bank notes or ID cards.

Therefore, the product according to the present invention is preferably a decorative and/or security product.

Decorative and/or security products of the present invention are meant to include banknotes, passports, identification documents, smart cards, driving licenses, share certificates, bonds, cheques, cheque cards, tax banderols, postage stamps, tickets, credit cards, debit cards, telephone cards, lottery tickets and gift vouchers, but also packing materials based on polymer and/or metal(lized) foils, paper or card board, wall papers, tissue materials, product labels, decorative elements or labels on shoes, clothes, cosmetics, sporting goods, computer hard- and software and the like.

All of the products mentioned may be provided with multicoloured coatings in an easy and cost saving way, using merely two different coating compositions to achieve at a great variety of possible colours, which are not only visible in the visible region of light, but may be hidden when viewed under ambient illumination and may be observed by means of IR or UV illumination and/or with the help of linear polarisers. The resulting coatings are not only highly attractive due to their outstanding colour characteristics such as high chroma, high purity and/or optical variability, but may also advantageously be used in security applications for the production of security products bearing hidden information. The present invention provides a highly versatile method for the production of highly versatile coloured products by simply using so few as two different coating solutions in a simple coating procedure. In addition, almost all kinds of common planar substrates may be used, thus broadening the options to provide products on demand for the corresponding customer, either in decorative or, in particular, in security applications.

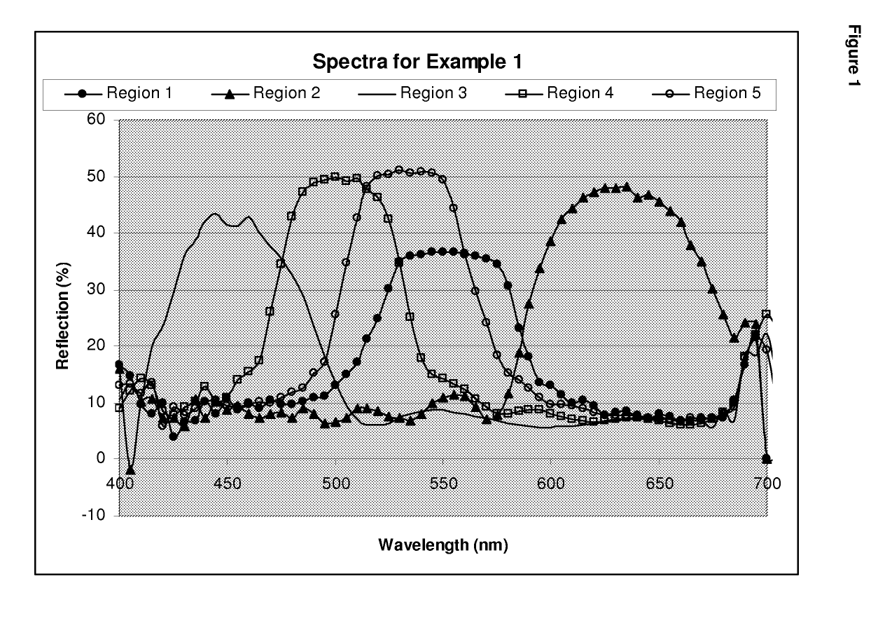

The present invention is described in more detail in the following examples as well as FIGS. 1 to 4, which are intended to merely illustrate but not to restrict the scope of the present invention.

FIG. 1 discloses the reflection spectra measured with an Ocean optics spectrophotometer of a polymerised multicoloured coating according to the invention (example 1) wherein a first cholesteric LC coating composition is applied onto a black PET substrate, followed by a second cholesteric LC coating composition, whereby some areas overlap

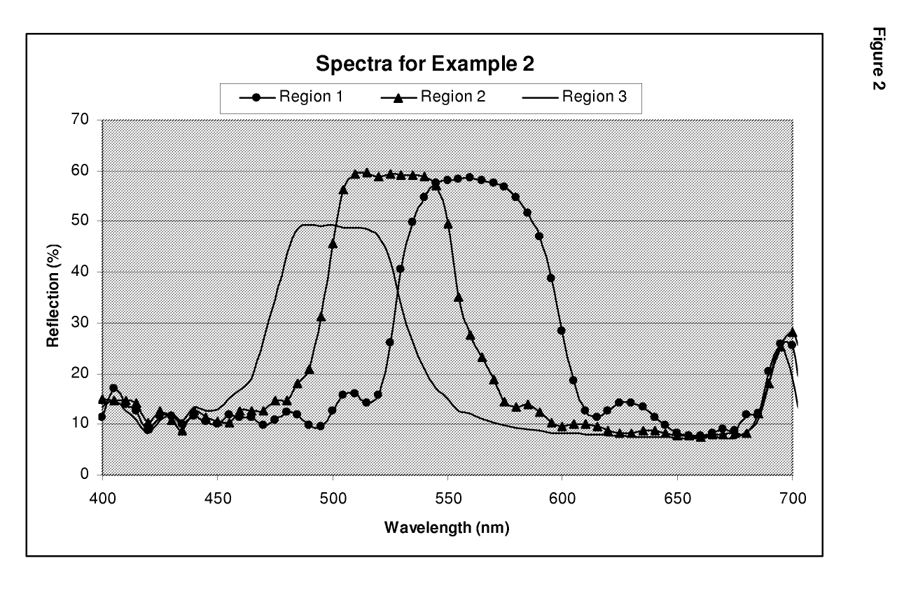

FIG. 2 discloses the reflection spectra of the overlapping areas according to example 2, whereby the coating of the first and second cholesteric LC coating compositions of example 1 has been executed in an inverse sequence

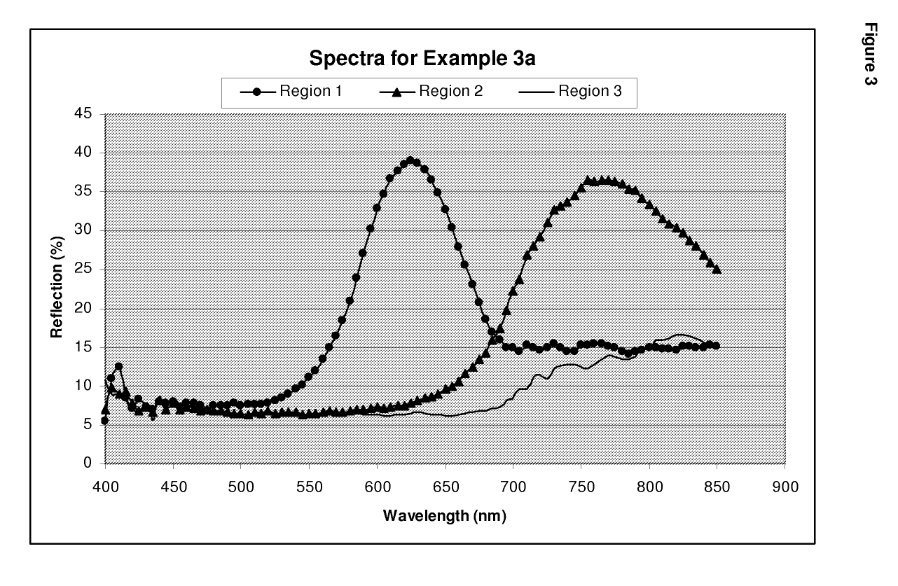

FIG. 3 discloses the reflection spectra of the overlapping areas according to example 3a, where a nematic LC composition is used for the first coating composition and a cholesteric LC composition is used for the second coating composition

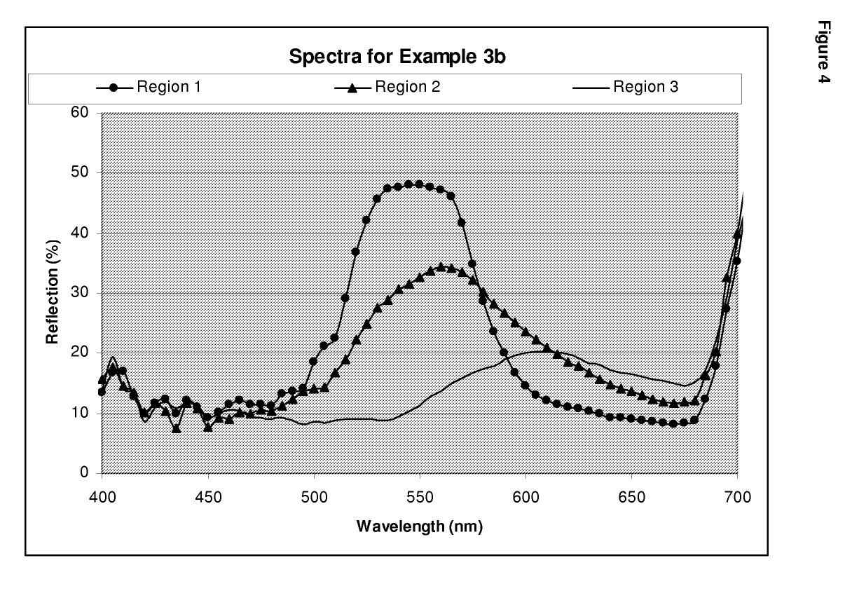

FIG. 4 discloses the reflection spectra of the overlapping areas according to example 3b which is a comparative example, where example 3a is repeated except that the first coating composition was partly polymerised prior to coating the second coating composition

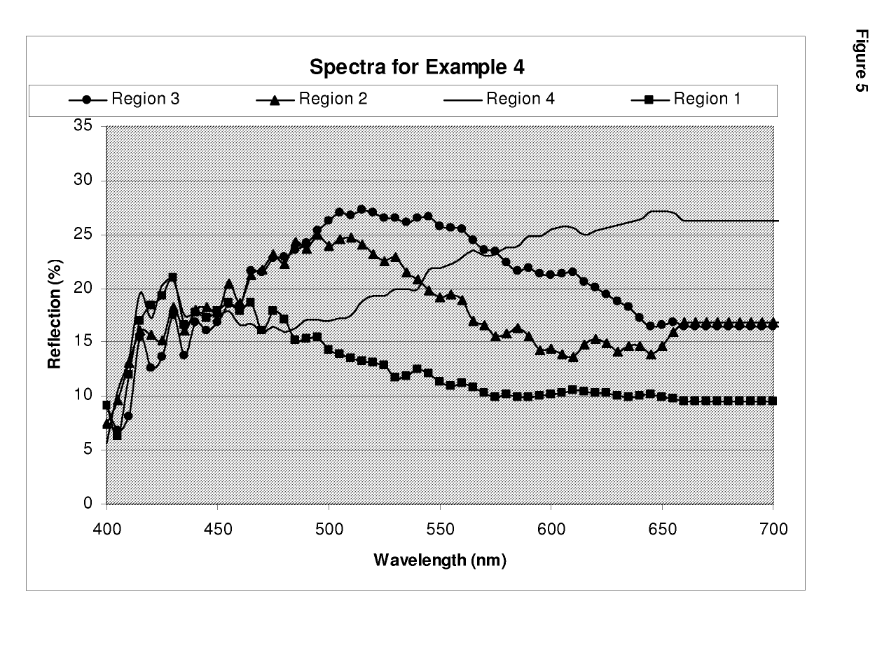

FIG. 5 discloses the reflection spectra of the overlapping areas according to example 4, where a nematic LC composition is used for the first as well as for the second coating composition

In the foregoing and in the following examples, unless otherwise indicated, all temperatures are set forth uncorrected in degrees Celsius and all parts and percentages are by weight.

### EXAMPLES

In the following examples two application techniques and 3 different solutions were used.

The solutions were
A A Blue reflecting cholesteric liquid crystal in solvent
B A Red reflecting cholesteric liquid crystal in solvent
C A nematic liquid crystal in solvent.

The solvent and solution concentrations were the same in each case.

The application techniques used were
1a. Bar coating with a 4 μm bar leaving a final coating thickness (after evaporation of solvent) of 1 g per square metre
1b. Bar coating with a 6 μm bar leaving a final coating thickness (after evaporation of solvent) of 1.5 g per square metre
2. Gravure printing with three distinct regions with thicknesses of 1.5, 2.0 and 4.0 g per square metre

The liquid crystal coatings were polymerised by exposure to UV radiation (UVA-0.14 J/cm², UVB-0.078 J/cm², UVC-0.014 J/cm²)

The following LC compounds were used:

A*

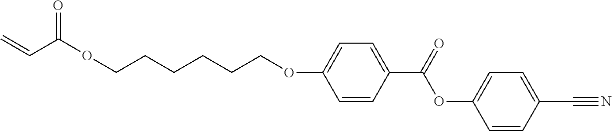 [SMILES: C=CC(=O)OCCCCCCOc1ccc(C(=O)Oc2ccc(C#N)cc2)cc1]

B*

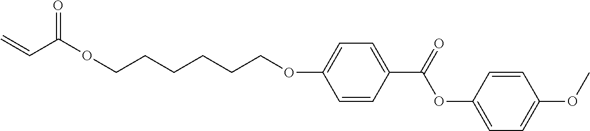 [SMILES: C=CC(=O)OCCCCCCOc1ccc(C(=O)Oc2ccc(OC)cc2)cc1]

C*

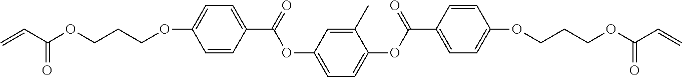 [SMILES: C=CC(=O)OCCCOc1ccc(C(=O)Oc2ccc(OC(=O)c3ccc(OCCCOC(=O)C=C)cc3)c(C)c2)cc1]

D*

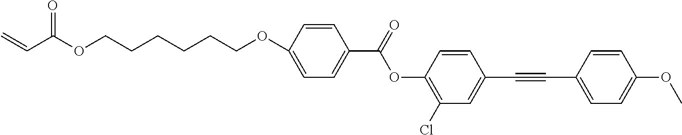 [SMILES: C=CC(=O)OCCCCCCOc1ccc(C(=O)Oc2ccc(C#Cc3ccc(OC)cc3)cc2Cl)cc1]

E*

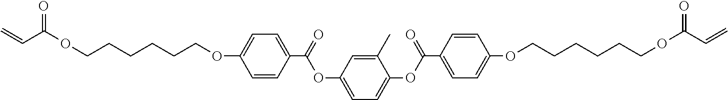 [SMILES: C=CC(=O)OCCCCCCOc1ccc(C(=O)Oc2ccc(OC(=O)c3ccc(OCCCCCCOC(=O)C=C)cc3)c(C)c2)cc1]

F*

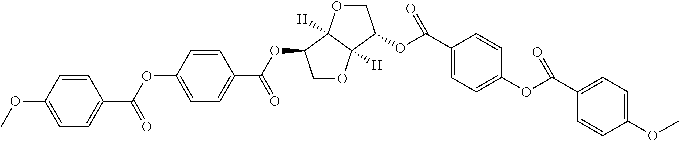

| | | | |
|---|---|---|---|
| Compound | Solution A | Solution B | Solution C |
| A* | 5.1% | 5.3% | 14.3% |
| B* | 1.7% | 1.7% | 14.2% |
| C* | 27.7% | 28.0% | 16.0% |
| D* | 5% | 5.0% | |
| E* | 6.8% | 7.0% | 3.9% |
| F* | 2.1% | 1.4% | |
| Irgacure | 1.5% | 1.5% | 1.5% |
| 369 | | | |
| Irganox | 0.05% | 0.05% | 0.05% |
| 1076 | | | |
| Surfactant | 0.05% | 0.05% | 0.05% |
| Cyclo- | 50% | 50.0% | 50% |
| hexanone | | | |

Irgacure® 369 is a polymerisation initiator and Irganox® 1076 is an anti-oxidants, both commercially available from Ciba Geigy AG.

The liquid crystal compounds A* to F* are commercially available from Merck KGaA, Germany.

### Example 1

Solution A was bar coated onto a black metallised PET foil using the 6 μm bar.

Solution B was gravure printed onto the coated film. The coating was slightly offset so that some of solution B was applied to the uncoated substrate.

The foil was then annealed at 70° C. to remove residual solvent before polymerising

The final film had regions with 5 different colours. The reflection spectrum for each of the 5 regions is shown in FIG. 1.

The following table shows the relative quantities of each Liquid Crystal layer and the peak reflection wavelength.

| | Amount of | Amount of | Reflection Peak |
|---|---|---|---|
| Region | Solution A | Solution B | Midpoint (nm) |
| 1 | 1.5 | 0 | 452 |
| 2 | 1.5 | 1.5 | 502 |
| 3 | 1.5 | 2.0 | 533 |
| 4 | 1.5 | 4.0 | 553 |
| 5 | 0 | 2.0 | 633 |

### Example 2

Solution B was bar coated onto a black metallised PET foil using the 6 μm bar.

Solution A was gravure printed onto the coated film. The foil was then annealed at 70° C. to remove residual solvent before polymerising.

The final film had regions with 3 different colours in addition to the unaffected red colour from the background. The reflection spectrum for each of the 3 regions is shown in FIG. 2.

The following table shows the relative quantities of each Liquid Crystal layer and the peak reflection wavelength.

| | Amount of | Amount of | Reflection Peak |
|---|---|---|---|
| Region | Solution B | Solution A | Midpoint (nm) |
| 1 | 1.5 | 1.5 | 563 |
| 2 | 1.5 | 2.0 | 526 |
| 3 | 1.5 | 4.0 | 502 |

### Example 3

### Example 3a

Solution C was bar coated onto a black metallised PET foil using the 4 μm bar.

Solution A was gravure printed onto the coated film. The foil was then annealed at 70° C. to remove residual solvent before polymerising.

The final film had 4 different regions. The background nematic showed no reflection colour. The reflection spectrum for each of the 3 combination regions is shown in FIG. 3.

The following table shows the relative quantities of each Liquid Crystal layer and the peak reflection wavelength.

| | Amount of | Amount of | Reflection Peak |
|---|---|---|---|
| Region | Solution C | Solution A | Midpoint (nm) |
| 1 | 1.0 | 4.0 | >900 |
| 2 | 1.0 | 2.0 | 750 |
| 3 | 1.0 | 1.5 | 625 |

Region 3 is invisible at normal viewing but a feint red colour is apparent when viewed at an angle. This is indicative of a cholesteric reflection band in the infra-red region of the spectrum.

### Example 3b

### Comparative Example

(example 3a was repeated except that the process of applying and curing of the respective LC layers was performed as described in claim 1 of patent application EP 1 894 736 A2 referred to in the present specification)

Solution C was bar coated onto a black metallised PET foil using the 4 μm bar. This coating was partially polymerised by exposure to UV radiation. (UVA-0.014 J/cm², UVB-0.008 J/cm², UVC-0.002 J/cm²)

Solution A was gravure printed onto the coated film. The foil was then annealed at 70° C. to remove residual solvent before polymerising.

The final film had 4 different regions. The background nematic showed no reflection colour. The reflection spectrum for each of the 3 combination regions is shown in FIG. 4.

The following table shows the relative quantities of each Liquid Crystal layer and the peak reflection wavelength.

| | Amount of | Amount of | Reflection Peak |
|---|---|---|---|
| Region | Solution C | Solution A | Midpoint (nm) |
| 1 | 1.0 | 4.0 | 547 |
| 2 | 1.0 | 2.0 | 560 |
| 3 | 1.0 | 1.5 | 605 |

Example 3a in comparison to the comparative example 3b shows that the method according to the present invention gives access to a much wider range of colours than that described previously in patent application EP 1 894 736 A2.

### Example 4

Solution C was bar coated onto a black metallised PET foil using the 4 μm bar.

Next, solution C was gravure printed onto the previously coated film.

The foil was then annealed at 70° C. to remove residual solvent before polymerising.

The final film had regions with 4 different colours. The reflection spectrum for each of the 4 regions is shown in FIG. 5.

The following table shows the colour visible when viewed through a linear polariser at the correct orientation for each of the 4 regions.

| | First layer | Second layer | |
|---|---|---|---|
| | of solution C | of solution C | |
| Region | (g/m²) | (g/m²) | Colour |
| 1 | 1.0 | 0 | Deep Blue |
| 2 | 1.0 | 1.5 | Dull Purple |
| 3 | 1.0 | 2.0 | Yellow-Green |
| 4 | 1.0 | 4.0 | Blue-Green |

1. Method for producing multicoloured coatings on a substrate by coating a first coating composition containing a first polymerisable nematic liquid crystal material onto a substrate and subsequently coating a second coating composition containing a second polymerisable nematic liquid crystal material onto the substrate while the first coating composition is still in an unpolymerised state, wherein the first and the second coating composition overlap in at least one defined area, followed by polymerisation of the resulting coating.

2. Method according to claim 1, wherein the first and the second coating composition differ in their birefringence.

3. Method according to claim 1, wherein at least one of the first or the second coating compositions contains a chiral dopant.

4. Method according to claim 3, wherein the first and the second coating composition contains a chiral dopant.

5. Method according to claim 1, wherein the first and the second coating composition overlap at two or more defined areas and wherein the first and second coating composition overlap at a first mixing weight ratio in a first defined area and at a second mixing weight ratio in at least a further defined area.

6. Method according to claim 1, wherein the first and the second coating composition is coated onto the substrate by a bar coating, gravure coating and/or reverse gravure coating process.

7. Method according to claim 1, wherein the first and the second coating composition is coated onto the substrate by a gravure printing, flexographic printing and/or ink jet printing process.

8. Multicoloured coating on a substrate, produced by a method according to claim 1.

9. Multicoloured coating according to claim 8, exhibiting at least three different colour hues when viewed under a perpendicular viewing angle.

10. Multicoloured coating according to claim 8, exhibiting at least three different colour hues when viewed under an acute viewing angle.

11. Multicoloured coating according to claim 8, wherein at least one of the colours of the coating is visible when viewed with a linear polarisator.

12. Multicoloured coating according to claim 8, wherein at least one of the colours of the coating is visible when viewed under IR or UV illumination.

13. Multicoloured coating according claim 8, wherein the colours of the coating are visible when viewed with the naked eye.

14. Product, containing a multicoloured coating according to claim 8.

15. Product according to claim 14, which is a coated paper, coated board, coated wall paper, coated decorative product or coated security product.

16. Product according to claim 14, which is a banknote, a passport, an identification document, a smart card, a driving license, a share certificate, a bond, a cheque, a cheque card, a tax banderol, a postage stamp, a ticket, a credit card, a debit card, a telephone card, a lottery ticket or gift voucher, a packing material based on polymer and/or metal(lized) foils or paper or card board, a wall paper, a tissue material, a product label, or a decorative element or label on shoes, clothes, cosmetics, sporting goods or on computer hard- and software.
